(19) United States
(12) Patent Application Publication
(10) Pub. No.: US 2017/0083974 A1
(43) Pub. Date: Mar. 23, 2017

(54) SYSTEMS AND METHODS FOR IDENTIFICATION AND ANALYSIS OF SECURITIES TRANSACTIONS ABNORMALITIES

(71) Applicant: BasisCode Technologies, LLC, Atlanta, GA (US)

(72) Inventor: Carlos Guillen, Atlanta, GA (US)

(21) Appl. No.: 15/150,986

(22) Filed: May 10, 2016

Related U.S. Application Data
(60) Provisional application No. 62/219,918, filed on Sep. 17, 2015.

(51) Int. Cl. G06Q 40/04

(52) U.S. Cl. CPC G06Q 40/04

(57) ABSTRACT

System and methods for analyzing and making actionable stock and securities data, and more particularly to analyzing securities data and purchases in connection with news events to identify and analyze abnormalities in securities purchases relating to insider trading. A module comprised of market data as well as news and events related to securities and multiple Z-score market move mechanisms. Embodiments of the module also include historical pricing, historical percentage change, and historical volume for securities. In addition, the historical percentage change is also included for security indices and benchmarks. Market data is pulled into the module automatically then normalized to determine the output. The module calculates whether or not financial transactions are potentially nefarious to investment firms by applying targeted trades to market movements. Associated security news and events are produced and published to a dashboard and alert screen in an interactive format.

### CLAIM OF PRIORITY

This application claims the benefit of and priority to U.S. Provisional Patent Application No. 62/219,918, filed Sep. 17, 2015, entitled “SYSTEMS AND METHODS FOR IDENTIFICATION AND ANALYSIS OF SECURITIES TRANSACTIONS ABNORMALITIES,” incorporated herein by reference in its entirety.

### TECHNICAL FIELD

The present systems and methods relate generally to analyzing and making actionable stock and securities data, and more particularly to analyzing securities data and transactions in connection with news events to identify and analyze abnormalities in securities transactions relating to insider trading and present information on such abnormalities to a user via an interactive dashboard.

### BACKGROUND

Insider trading, the practice of trading a public company's stock or other securities by individuals with access to material non-public information about the company, is considered a crime in many countries. Proving insider trading, however, can be very difficult. In particular, demonstrating with reasonable certainty that a given individual (or person that makes a securities exchange for the individual) had non-public information that led to the purchase or sale of a security is very challenging. Other challenges include collecting relevant data from disparate sources, and once the data is analyzed, displaying that data in an interactive and informative manner to a user. Further challenges include utilizing the data in a way to take meaningful actions with respect to the intelligence learned from the data.

Therefore, there is a long-felt but unresolved need for a system or method that helps analyze potential abnormalities in stock or securities purchases or sales in an analytical, data-driven, and interactive way to enable better assessment of possible illegal securities trades.

### BRIEF SUMMARY OF THE DISCLOSURE

Briefly described, and according to one embodiment, aspects of the present disclosure generally relate to systems and methods for analyzing and making actionable stock and securities data, and more particularly to analyzing securities data and transactions in connection with news events to identify and analyze abnormalities in securities transactions that may reflect insider trading.

In one embodiment, a system, comprising a computer server programmed to receive trade data corresponding to a plurality of financial security trades, each financial security trade associated with a financial security; receive market data for each of said financial securities for a predetermined time period; receive market index data for an index associated with each of said financial securities; calculate a daily statistic for each of said financial securities based on said market data and market index data; generate an alert for any of said financial security trades made within a predetermined time period of its respective daily statistic indicating an outlier in trading for the respective financial security; an interactive display device for interacting with a user, coupled to said computer server, and programmed to receive said alert from said computer server; and display the alert to a user.

In one embodiment, a system, comprising a first communication link to a financial company, wherein said financial company provides by said first communication link a description of at least one financial security trade, including at least a trader identifier, trade date, transaction type, security identifier, and quantity; a second communication link to a source of current financial securities and news data, wherein said source provides by said second communication link data for each security identified in said descriptions of financial security trades, said data including at least price history for the security, volume history for the security, price history for an associated index, and news items about the security; a computer server coupled to the first communication link and second communication link, and programmed to compute a daily percentage change for each such security identified over a specified period of time; compute a daily percentage change for each such associated index over the specified period of time; compute a difference between the daily security percentage change and daily associated index percentage change, for each such security identified over the specified period of time; compute a mean of such differences, for each such security identified over the specified period of time; compute a standard deviation of such differences, for each such security identified over the specified period of time; compute a daily z-score for each security identified over the specified period of time, wherein the z-score is said mean for one such security subtracted from said difference for said security on one date, the result of said subtraction then divided by said standard deviation for said security; generate an alert if one of said at least one financial security trades has a trade date near a date when the z-score for said financial security was more than about 2; an interactive display devices for interacting with a user, coupled to said computer server, and programmed to receive an alert and display the alert to a user.

In one embodiment, a system, comprising a first communication link to a financial company; a second communication link to a source of current financial securities and news data; a computer server coupled to the first communication link and second communication link, and programmed to: receive, from the first communication link, trade data corresponding to a plurality of financial security trades, each financial security trade associated with a financial security; receive, from the second communication link, market data for each of said financial securities; receive, from the second communication link, market index data for an index associated with each of said financial securities; automatically identify any dates that the movement of any of said financial securities is an outlier, based on said market data and market index data; automatically identify any of said financial security trades made close to one of said identified dates of outliers for that security, wherein said security trade is an abnormal trading pattern; in response to identification of at least one abnormal trading pattern in the trading of a financial security, automatically retrieving from the second communication link news items associated with the date of said abnormal trading pattern; an interactive display device for interacting with a user, coupled to said computer server, and programmed to receive an alert from said computer server including at least one said identified abnormal trading pattern; display a chart of the recent movement of said financial security, wherein said chart graphically indicates dates of said outliers; receive user input from a graphical indicator device, wherein the user input comprises a selection from said chart of one said outlier; and display at least one news item associated with said outlier.

According to various aspects of the present disclosure, the system, wherein the daily statistic is a z-score calculated by first calculating a daily percentage change in price of a financial security from the market data, second calculating a daily percentage change in price of an associated index from the market index data, third calculating the daily difference of the daily percentage change in price of a financial security and the daily percentage change in price of an associated index, fourth calculating the mean of such daily differences, fifth calculating the standard deviation of such daily differences, then sixth calculating a daily statistic by subtracting said mean from the daily difference and dividing the result by said standard deviation. Further, the system, wherein an outlier in the daily statistic is indicated if the daily statistic is greater than about 2. Further, the system, wherein the computer server is further programmed to receive news items for the financial security that generated the alert. Further, the system, wherein the interactive display device for interacting with a user is further programmed to display a chart of movement of the financial security that generated the alert, wherein said chart graphically indicates dates of outliers in trading for that financial security; receive user input from a graphical indicator device, wherein the user input comprises a selection from said chart of one said outlier; and display at least one news item associated with said outlier. Further, the system, wherein the computer server is further programmed to calculate a volume daily statistic, the volume daily statistic calculated by first calculating the mean of daily volume values for the financial security from the market data, second calculating the standard deviation of daily volume values for the financial security from the market data, then third calculating a daily statistic by subtracting said mean from a daily volume for the financial security and dividing the difference by said standard deviation. Further, the system, wherein an outlier in the volume daily statistic is indicated if the volume daily statistic is greater than about 2. Further, the system, wherein the computer server is further programmed to filter out financial security trades where the quantity of traded securities is less than a specified quantity. Further, the system, wherein the computer server is further programmed to filter out financial security trades that occur more than a specified number of days before or after an outlier in trading for that financial security. Further, the system, wherein the computer server is further programmed to filter out financial security trades where a transaction type is buy prior to an outlier that represents a decrease in the price of that financial security. Further, the system, wherein the computer server is further programmed to filter out financial security trades where a transaction type is sell prior to an outlier that represents an increase in the price of that financial security. Further, the system, wherein the computer server is further programmed to take an automated action in response to said alert.

According to various aspects of the present disclosure, the system, wherein the interactive display device for interacting with a user is further programmed to display a chart of movement of the financial security that generated the alert, wherein said chart graphically indicates dates of outliers in trading for that financial security; receive user input from a graphical indicator device, wherein the user input comprises a selection from said chart of one said outlier; display at least one news item associated with said outlier. Further, the system, wherein the computer server is further programmed to filter out financial security trades that occur more than a specified number of days before or after an outlier in trading for that financial security. Further, the system, wherein the computer server is further programmed to filter out financial security trades where a transaction type is buy prior to an outlier that represents a decrease in the price of that financial security. Further, the system, wherein the computer server is further programmed to filter out financial security trades where a transaction type is sell prior to an outlier that represents an increase in the price of that financial security. Further, the system, wherein the computer server is further programmed to take an automated action in response to said alert.

According to various aspects of the present disclosure, the system, wherein an outlier in the movement of any of said financial securities is determined by first calculating a daily percentage change in price of a financial security from the market data, second calculating a daily percentage change in price of an associated index from the market index data, third calculating the daily difference of the daily percentage change in price of a financial security and the daily percentage change in price of an associated index, fourth calculating the mean of such daily differences, fifth calculating the standard deviation of such daily differences, sixth calculating a daily statistic by subtracting said mean from the daily difference and dividing the result by said standard deviation, then seventh determining the daily statistic is an outlier if the daily statistic is greater than about 2. Further, the system, wherein the interactive display device for interacting with a user is further programmed to display a chart of movement of the financial security that generated the alert, wherein said chart graphically indicates dates of outliers in trading for that financial security; receive user input from a graphical indicator device, wherein the user input compromises a selection from said chart of one said outlier; display at least one news item associated with said outlier. Further, the system, wherein the computer server is further programmed to: filter out financial security trades that occur more than a specified number of days before or after an outlier in trading for that financial security. Further, the system, wherein the computer server is further programmed to filter out financial security trades where a transaction type is buy prior to an outlier that represents a decrease in the price of that financial security. Further, the system, wherein the computer server is further programmed to filter out financial security trades where a transaction type is sell prior to an outlier that represents an increase in the price of that financial security. Further the system, wherein the computer server is further programmed to take an automated action in response to said alert.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an exemplary compliance analysis system according to one embodiment of the present disclosure.

FIG. 2 shows an exemplary stock chart with outliers where the security significantly diverges from an index, according to one embodiment of the present disclosure.

FIG. 3 shows an exemplary z-score chart, according to one embodiment of the present disclosure.

FIG. 4 shows an exemplary chart of news and events, according to one embodiment of the present disclosure.

FIG. 5 shows an exemplary securities transaction compliance process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for analyzing and making actionable stock and securities data, and more particularly to analyzing securities data and transactions in connection with news events to identify and analyze abnormalities in securities purchases relating to insider trading and present information on such abnormalities to a user via an interactive dashboard.

It is an object of the present disclosure to provide technology for collecting data relating to financial security transactions, financial security data, and news data, and analyze that data for abnormalities in the security transactions that may indicate insider trading. It is a further object of the present disclosure to provide a “z-score” that may be compared to transaction data to indicate possible insider trading. It is a further object of the present disclosure to provide a dashboard with access to an underlying alert for a user to interactively investigate abnormalities in trading data. It is a further object of the present disclosure to autonomously take action in response to abnormalities in trading data.

As described herein, a “client” may represent a company or entity using an embodiment of the present systems or methods (such as the financial company described in the example scenario below).

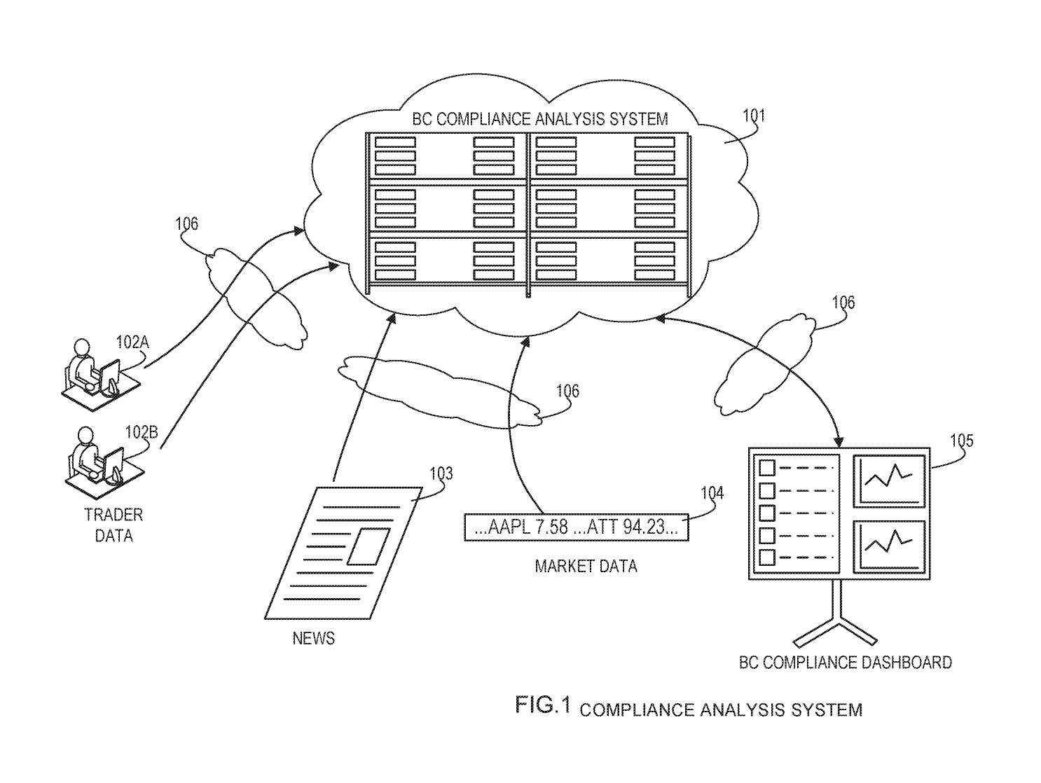

Now, referring to the drawings, FIG. 1 shows a compliance analysis system 101 according to aspects of the present disclosure. In one embodiment, the compliance analysis system 101 is a cloud-based computing system, a web application, SaaS product, or similar type of system. In other embodiments the compliance analysis system 101 is any computing system, such as rack servers illustrated in FIG. 1, a local or virtual server, desktop computer, laptop computer, mobile device, or any particular collection of computer hardware and software modules necessary to perform the functionalities described in this disclosure.

As a non-limiting and illustrative example, and still referring to FIG. 1, assume that a finance company that employs several hundred people would like to mitigate the risk inherent among portfolio managers who trade on behalf of the firm and employees who trade in their personal accounts with respect to the misuse of material non-public information. To minimize this risk, the company subscribes to an embodiment of the present systems and methods. The firm then feeds in or enables both their firm trades, made my portfolio managers 102A, and trades made by employees on their personal accounts 102B, to be sent directly into an aspect of the compliance analysis system 101 on a regular basis. The trade data is transmitted across communication link 106. In various embodiments, the trade data may be transmitted directly from the firm or from a third party. The trade data may be transmitted using any of various standard transmission methods, such as batch scripts, file transfer tools, or manual uploads. Accordingly, this aspect of the present system has access to market trade data of the finance company and its employees.

The embodiment of the compliance analysis system 101 will then normalize the finance company's data, meaning that data from various firms is in different formats and is converted to a common format. In various embodiments, the compliance analysis system 101 will also retrieve market data points from a market data provider 104 for securities and indices such as price, volume, and percent change from last close. In some embodiments, the compliance analysis system 101 will also retrieve news and market moving events for a specified time period from a news provider 103. The market data and news is transmitted across a communication link 106. The market data provider 104 and news provider 103 may be any provider of electronic market data or news, such as Bloomberg, Interactive Data, Reuters, etc. In various embodiments, the compliance analysis system 101 uses an Application Programming Interface (API) to connect to market data provider 104 and news provider 103.

In various embodiments, the compliance analysis system 101 then analyzes this data. In various embodiments, if certain criteria are met, the system 101 publishes an “alert” to the finance company via the interactive compliance dashboard 105. In various embodiments the dashboard 105 may be an interactive display device, such as a desktop computer, interactive kiosk, laptop computer, tablet, or mobile device. In one embodiment the dashboard 105 may display an “alerts” screen with information on one or more alerts. These “alerts” represent abnormal trades that may relate to potential misuses of material non-public information. In some embodiments, the analysis includes the z-score for a security, where the z-score is a daily statistical measure calculated in part from the difference of the percentage change from the last market close for a given security versus its respective index for a specified time period. In one embodiment, an alert is generated if a trade of a security occurs within a preset number of days before or after an outlier in the z-score of the security.

The alerts are available for compliance officers or users at the finance company to review and report via the interactive compliance dashboard 105, which may include an alerts screen. In various embodiments the abnormal trades are displayed on the compliance dashboard 105 with access to the underlying alert accompanied by corresponding charts and links to market moving news and events. By clicking on the charts and links displayed on the interactive compliance dashboard 105, the user can “drill down” on the abnormal trade to determine if the transaction should be further investigated as a possible breach of policy. In one embodiment the user may create an on-demand test or report that documents all of the associated findings with the transaction and individual as well as establish an audit trail. The compliance analysis system 101 connects to the compliance dashboard via communication link 106.

In some embodiments, an alert is accompanied by some automatic action by the compliance analysis system 101, such as generating a report on the abnormal trade, automatically notifying a regulatory agency, etc. In one embodiment, the automatic action is stopping the trader from making further trades, for example by freezing the trader's account access. Other actions that can be automated with respect to the present disclosure may be contemplated as will occur to one having ordinary skill in the art.

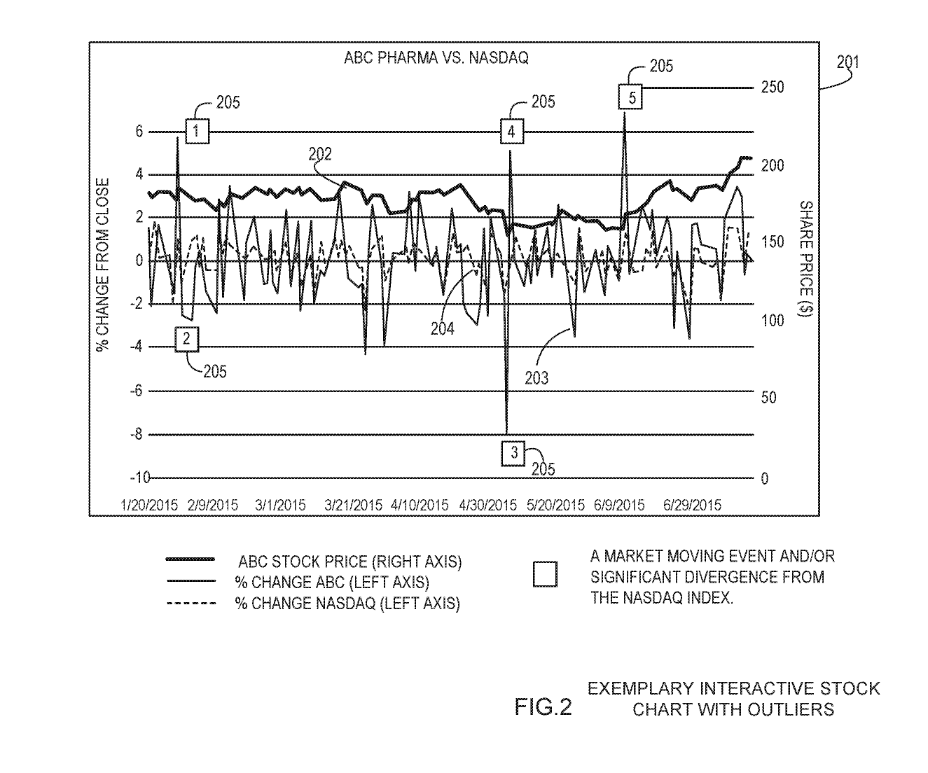

FIG. 2 illustrates an example interactive chart 201 that may be displayed on the compliance dashboard 105, according to some embodiments. The chart shows the daily closing price of an exemplary and fictional stock, ABC Pharmaceuticals, over a period in 2015 (202). The chart also shows the percentage change from the previous market close for ABC Pharmaceuticals (203), as well the percentage change from the previous market close for an index corresponding to ABC, in this case NASDAQ (204). Also, outliers where the security significantly diverges from the index are notated by numbered square icons 205, which may correspond to market moving news and events. Instances of significant divergence are also referred to herein as outliers. Square icons 205 may be hotlinks. When the user clicks on one of the icons 205, the dashboard 105 displays associated news and events.

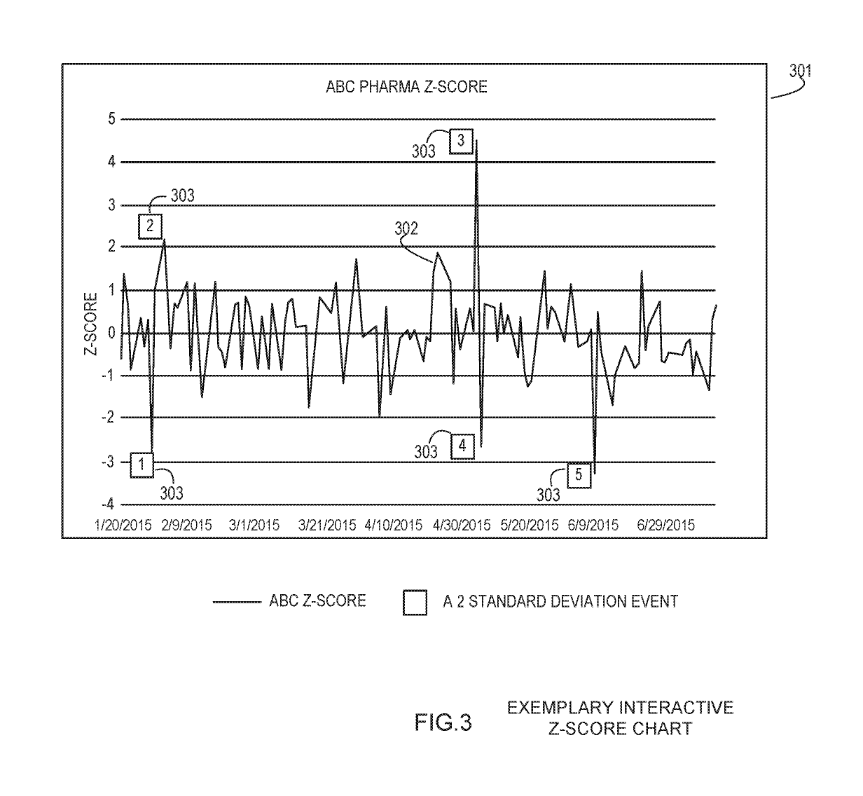

FIG. 3 illustrates an example interactive chart 301 shown on the compliance dashboard 105, according to some embodiments of the present disclosure. In this embodiment, an alert screen view generally illustrates a z-score (302), a statistical measure calculated in part from the difference of the percentage change from the last market close for a given security (in this non-limiting example, the security is ABC Pharmaceuticals), versus its respective index, the NASDAQ, for a specified time period. In this embodiment, the outliers notated by numbered square icons 303 represent an event exceeding 2 standard deviations. These ‘events’ may correspond to market moving events and news. Square icons 205 may be hotlinks. When the user clicks on one of the icons 205, the dashboard 105 displays associated news and events. The methodologies used to calculate the above-illustrated z-score and other analyses described and shown herein are described in more detail below.

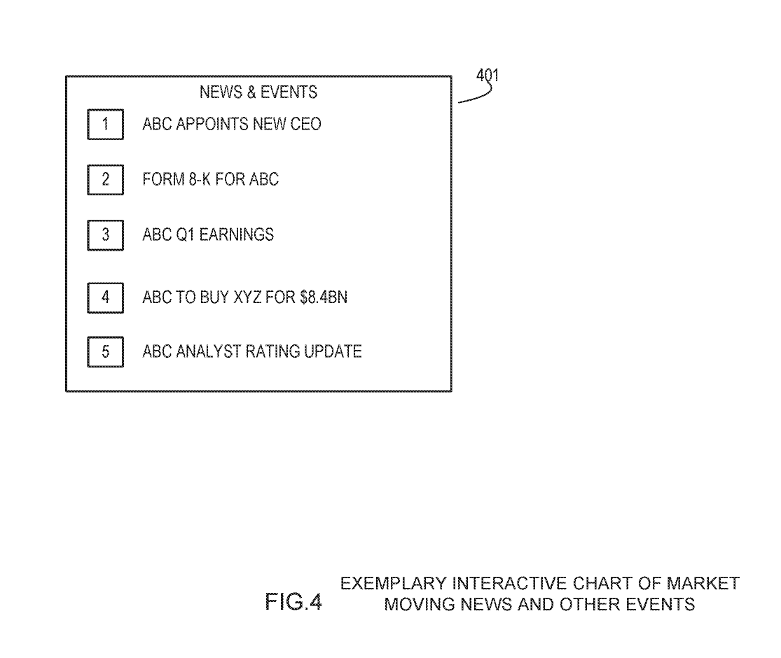

FIG. 4 illustrates a chart 401 that may be shown on the compliance dashboard 105, according to one embodiment of the present disclosure. The chart shows a table of market moving news and events for a specified security, in this case the table is showing news and events for ABC Pharmaceuticals (the same security described above in connection with FIGS. 2 and 3). These numbered square icons are associated to the outliers notated in FIGS. 2 and 3. These hotlinks enable a user to click further to view the underlying story.

As discussed above, the news events generally correlate to outliers in stock movement. Thus, in one non-limiting example, when a particular stock or security outlier is identified (as in FIGS. 2 and 3), the compliance analysis system 101 retrieves news data corresponding to that particular date or time frame from a provider 103 (e.g., from publicly-available sources, RSS feeds, etc.), such that the compliance dashboard can display a mapping between significant news for a given company and its change in stock price. In some embodiments, the compliance analysis system 101 does not retrieve or rely on news from provider 103.

In various embodiments, the compliance dashboard 105 offers several options for the user. Generally, the dashboard 105 displays high level information with the option for the user to “drill down” to see more detailed information. In one embodiment, the user can view alerts on the dashboard 105, where an alert may be a potential instance of insider trading, nefarious activity, or some other securities-related activity for which the user may desire information. The dashboard displays information about the alert, such as the date of the alert, the name of the individual trader who made a related trade, information about the financial security, and information about a compliance officer responsible for reviewing the alert. The compliance officer may click an available hotlink to see more information on the alert. In one embodiment, various types of information is shown on the dashboard 105, such as the top 5 financial securities that generate an alert, the number of violations and false alarms, visual representations that show trends in violations and false alarms, etc.

Once the compliance officer clicks on a hotlink to see more information on the alert, in one embodiment the dashboard 105 displays an alert screen with detailed information relevant to the alert. For example, the alert screen may include the individual trader's name, with a hotlink to see a profile with more information on that trader. The alert screen may include information on the trade in question. The alert screen may include news and events relevant to the trade in question, as illustrated by FIG. 4. The alert screen may show a visual or graph as illustrated by FIG. 2 and FIG. 3. The alert screen may show an audit trail of all actions taken on the by the user with respect to the current alert. The alert screen may allow the user to add comments for the user's future reference or for other compliance officers. The alert screen may allow the user to attach a file that is relevant to the alert, such as a trade confirmation. The alert screen may allow the user to initiate a discussion similar to a blog thread with people who may be users or not users of the system. The alert screen may allow the user to input their resolution of the case. The user may select an option to save their investigation and come back at a later time. The user may also select an option to escalate the alert to send the alert to another compliance officer for review.

The following is a discussion of how various embodiments of the compliance analysis system 101 receive and process market data 104. TABLE 1 below is an exemplary data table reflecting data pulled by an embodiment of the present system directly from a third-party market data provider 104, or calculated from such data. In particular, the left column (“Security Change From Last Close”) lists the change from market last close for a particular security. The right column (“Security Percent Change From Last Close”) lists the daily percentage change from the market last close for the same security. This data helps in both calculating the z-score shown in FIG. 3 and plotting the points shown in FIG. 2.

TABLE 1

| | Security Percent |
|---|---|
| Security Change From Last Close | Change From Last Close |
| 2.62 | 1.452 |
| −3.8 | −2.076 |
| 1.06 | 0.591 |
| 3 | 1.664 |

TABLE 2 below is an exemplary data table reflecting data retrieved from a third-party market data provider 104, or calculated from such data. In particular, the left-most column (“Index Previous Close”) shows a previous close value for an index associated with a particular security. The next column from the left (“Index Previous Close Date”) shows the closing date corresponding to the close value in the left-most column. The next column from the left (“Index Change”) is the daily change (raw value) from the previous day's close. The right most column (“Index Percent Change From Previous Close”) is the daily percentage change from the previous day's close. This data point helps in both calculating the z-score shown in FIG. 3 and plotting the points shown in FIG. 2.

TABLE 2

| | | | Index Percent |
|---|---|---|---|
| | Index Previous | | Change From |
| Index Previous Close | Close Date | Index Change | Previous Close |
| 5145.1756 | Jan. 16, 2015 | 22.7199 | 0.4416 |
| 5167.8955 | Jan. 20, 2015 | 13.9777 | 0.2705 |
| 5181.8732 | Jan. 21, 2015 | 92.1333 | 1.778 |
| 5274.0065 | Jan. 22, 2015 | 8.308 | 0.1575 |

TABLE 3 below is an exemplary data table reflecting one methodology by which an embodiment of the present system takes data points from a data provider and calculates the z-score. The two primary data points used by an embodiment of the present system are the percentage change close for the security and a corresponding index. The details of how the z-score is calculated are discussed below.

TABLE 3

| Index Percent | Security Percent | | | |
|---|---|---|---|---|
| Change From | Change From | | | |
| Previous Close | Previous Close | Diff | Zscore | Abs zscore |
| 0.4416 | 1.452 | −1.0104 | −0.57284 | 0.572842 |
| 0.2705 | −2.076 | 2.3465 | 1.38184 | 1.38184 |
| 1.778 | 0.591 | 1.187 | 0.706677 | 0.706677 |
| 0.1575 | 1.664 | −1.5065 | −0.86172 | 0.861715 |

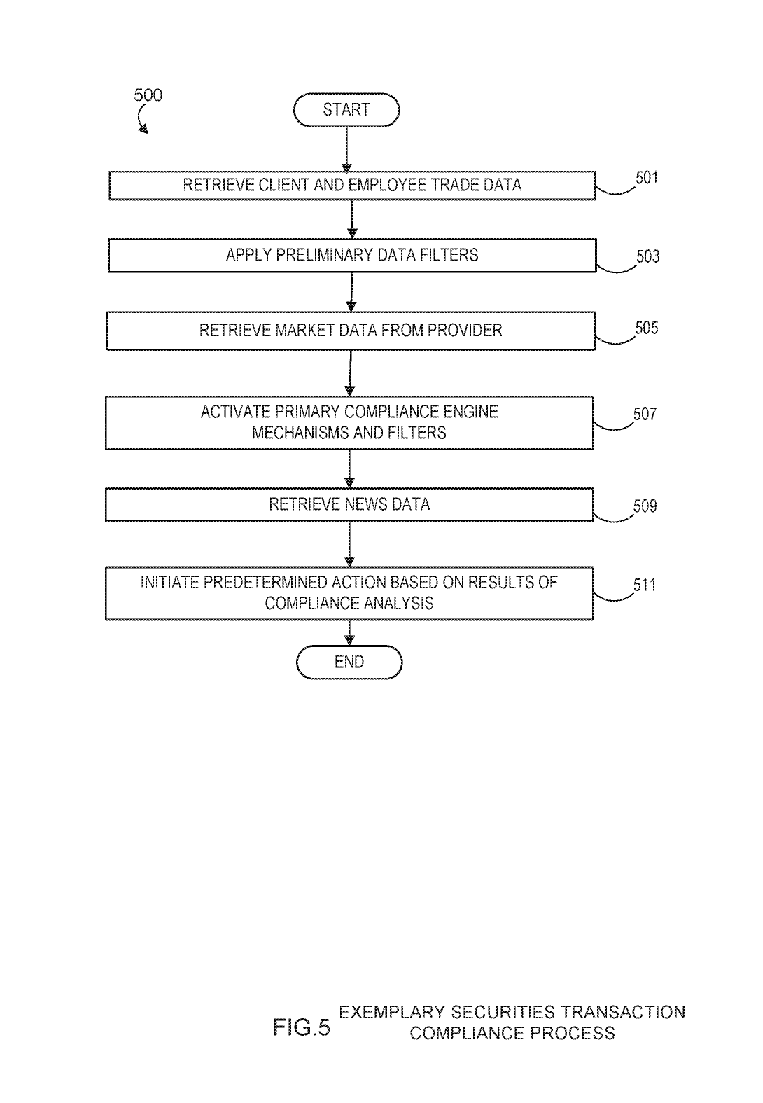

FIG. 5 is a flowchart illustrating a securities transaction compliance process 500 according to various embodiments of the present system. As will be understood by one having ordinary skill in the art, the steps and processes shown in FIG. 5 may operate concurrently and continuously, are generally asynchronous and independent, and are not necessarily performed in the order shown. In some embodiments, various steps and processes may be skipped entirely.

Starting at step 501, the compliance analysis system 101 receives security trade data such as client trades 102A and employee trades 102B via API, bulk upload file by the Client and/or Employee, direct broker feeds, or third party. Employee trades may be personal trades made by an employee or other trades attributable to a particular employee. In various embodiments the trade data is transmitted across communication link 106. In one embodiment, employee trades are imported into the compliance analysis system 101 from a third party Automated Broker Feed (“ABF”) aggregator or direct broker feed. In one embodiment, the data for each financial security trade should include at least an employee or entity identifier, trade date, the transaction type, a security identifier, and quantity. The employee or entity identifier indicates an employee or the client, and may be an employee's name or any other identifier, such as an Employee ID or Social Security Number. Example transaction types include buy, sell, sell short, or buy to cover a short sale. The security identifier may indicate any security by way of symbol, ISIN, Cusip or related identifier, such as stock, equity, U.S. Treasury bonds, U.S. Treasury bills, U.S. Treasury notes, municipal bonds, corporate bonds, international bonds, certificates of deposit, future, option, swaps, etc. Example security identifiers for stock trades include “AAPL” or “ATT.” The security identifier associates each financial trade with a particular financial security. The quantity indicates the number of securities to trade; for example the number of bonds or number of shares of stock. An example of complete data for one trade is: John Smith, Mar. 10, 2016, buy US 0378331005 (the ISIN number for AAPL), 100 shares.

At step 503, the compliance analysis system 101 may apply preliminary filters, such as a quantity filter or time filter. In various embodiments, the quantity filter excludes trades from further analysis where the quantity is less than some number “x.” The number “x” is configurable by a client of the compliance analysis system 101 and can be applied to both client and employee trades.

In various embodiments the time filter includes trades that occur N number of days before or after an outlier in the movement of the security. Other trades are filtered out from further analysis. For example, according to one embodiment, if a user trades IBM and N is set to 10 days, the compliance analysis system will look backward and forward 10 days from the trade date to determine if the security breached an outlier threshold (i.e. a z-score greater than 2) during that period. The user will be able to set this filter for both firm and employee trades.

At step 505, the compliance analysis system 101 retrieves various market data from a market data provider for securities identified in step 501. For each security, in various embodiments the market data may include, but is not limited to: (1) historical closing prices, (2) historical percentage change from the last closing price, (3) historical volume, (4) historical closing prices of an index associated with each security, and (5) the historical percentage change from the last closing price of an index associated with each security. The time period for the market data may be customized by the user. In other embodiments, the system may calculate the historical percentage change data. Any index may be used that measures a section of a financial market that includes the particular security. Example indexes include the S&P 500, NASDAQ, or Barclays' bond indices. To retrieve this data, in one embodiment the compliance analysis system 101 calls the market data provider's API.

At step 507, in various embodiments, the compliance analysis system 101 applies several primary algorithms to determine whether the trades are compliant. These algorithms may include, but are not limited to: direction move filter, large trade filter, compliance market move mechanism, and compliance volume move mechanism.

In one embodiment, the direction move filter excludes two types of trades: (1) the transaction type is buy prior to the security price decreasing some percentage X; or (2) sell prior to price increasing some percentage Y. The percentages X and Y may be customized by the user. These trades may be excluded from scrutiny because the timing, type of transaction, and the security's direction of price movement do not represent a gain for the trader.

In one embodiment, the large trade filter triggers an alert based on the size of the trade, independent of any subsequent price movement. The large trade filter may be triggered where the size of the trade is some percentage X of the security's daily volume. The percentage X may be customized by the user. For example if the filter is set to 10% and a trader makes an enormous buy in AAPL which accounts for 15% of AAPL's daily volume, then the compliance analysis system generates an alert. In various embodiments the alert is transmitted to the user's compliance dashboard 105.

In one embodiment, the market move mechanism identifies trades that satisfy filters described above that have been activated by the user, and where a scoring of a market move outlier (such as z-Score) exceeds some number of standard deviations (e.g., 2, selectable by the user). If so, then in various embodiments the compliance analysis system generates an alert and transmits it to the user's compliance dashboard 105.

As discussed above, TABLE 3 illustrates the calculation of a z-score according to one embodiment. The left-most column (“Index Percent Change From Previous Close”) is taken from TABLE 2. The next column (“Security Percent Change From Previous Close”) is taken from TABLE 1. The next column (“Diff”) is calculated by taking the difference of the Security Percent Change From Previous Close and the Index Percent Change From Previous Close. That is, the “Diff” value represents the difference between the percentage change from the previous close for the security as compared to its index. In the first row, for example, that results in a value of −1.0104.

To calculate the z-score, according to various embodiments, the compliance analysis system 101 next finds the mean of such differences for the particular security across a specified date range. Next, the system calculates the standard deviation of all such differences. Finally, the system calculates a daily Z-score for the security using the formula: (difference−mean)/standard deviation. This daily calculation for a particular security is shown by the column “zscore” in TABLE 3. The next column (“abs zscore”) is the absolute value of the zscore. Note that the mean and standard deviation of differences are not shown in TABLES 1-3. The result of the z-score is to statistically normalize such differences across a specified data range, such that the z-scores for a particular security can be used to effectively monitor volatility and trading patterns in relation to a specified index.

In various embodiments the compliance volume move mechanism is similar to the market move mechanism, but looks to changes in security volume rather than security price. In one embodiment, volume refers to the number of trades in a particular security per day. In various embodiments, the daily Volume Move z-score for a particular security is calculated by first taking the mean of the population of the daily volume values for a specified date range. Next the standard deviation of those values is taken and then the daily z-score is calculated by using the formula: (daily volume value−mean)/standard deviation. In various embodiments, the volume move mechanism identifies trades that satisfy the active criteria selected by the user. where the volume move z-score exceeds some number of standard deviations (e.g., 2, selectable by the user). If so, then in various embodiments the compliance analysis system generates an alert and transmits it to the user's compliance dashboard 105.

At step 509, the compliance analysis system receives news data from a news provider. In one embodiment, the system uses security identifiers to query the API of the news provider. The system retrieves the news items and may rank them chronologically within a window surrounding the trade date for each security. An example of ranking is as follows: a transaction of interest was made Sep. 25, 2015, one related news event occurred on Aug. 25, 2015, and a second news event occurred on Oct. 25, 2015; the events in the alert would be ranked chronologically as follows: Aug. 25, 2015 and then Oct. 25, 2015. In various embodiments the compliance analysis system does not perform step 509 and does not retrieve news data from a news provider.

At step 511, the compliance analysis system automatically takes action based on the previous steps and any alerts generated. In various embodiments, the compliance analysis system automatically transmits any alerts generated by the previous steps to the user's interactive compliance dashboard 105. The dashboard displays these alerts. In one embodiment, by clicking on the alert, compliance dashboard 105 displays additional information on the relevant trade by opening up an alert screen. The user can then determine whether or not the alert warrants a violation or should be dismissed. In some embodiments, the compliance analysis system 101 automatically causes the compliance dashboard 105 to open a case and document findings. In one embodiment, the compliance analysis system 101 automatically stops the trader from making further trades, for example by freezing the trader's account access. In various further embodiments, any automated action can be taken with respect to the information gleaned by the analysis system as will occur to one having skill in the art, including automatically generating a report, sending an alert to a supervisor's mobile device, initiating the collection of additional information about the trader or the trade, etc.

Alerts will be generated when a security that a firm or employee trades breaches algorithms and filters discussed above. Users may configure the rules. The current active set of rules will apply to all trades from that moment forward until if and when there is another filter or criteria adjustment. Depending on what criteria have been set, the key characteristics in generating an alert are the security in review, the timing of the trade, if said security behaved in an abnormal fashion in comparison to a relevant index, and if there are any corresponding news or events surrounding the transaction.

In addition to receiving alerts, users of the dashboard 105 and alert screens may open a blank alert (“on demand alert”) that may be used for whatever purpose they deem meaningful.

The dashboard 105 also allows the user to add comments, add attachments, add discussion (which is essentially a live communication thread between individuals that may or may not be users in the application), add a resolution, and a feature to save work on the alert for later. The dashboard 105 provides statistical information (e.g. number of false positives, exceptions (firm only, employee only, both, etc.)). In addition, the dashboard 105 offers the ability to have several levels of review by selected users.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A system comprising:
a computer server programmed to:
receive trade data corresponding to a plurality of financial security trades, each financial security trade associated with a financial security;
receive market data for each of said financial securities for a predetermined time period;
receive market index data for an index associated with each of said financial securities;
calculate a daily statistic for each of said financial securities based on said market data and market index data;
generate an alert for any of said financial security trades made within a predetermined time period of its respective daily statistic indicating an outlier in trading for the respective financial security;
an interactive display device for interacting with a user, coupled to said computer server, and programmed to:
receive said alert from said computer server; and
display the alert to a user.

2. The system of claim 1, wherein the daily statistic is a z-score calculated by first calculating a daily percentage change in price of a financial security from the market data, second calculating a daily percentage change in price of an associated index from the market index data, third calculating the daily difference of the daily percentage change in price of a financial security and the daily percentage change in price of an associated index, fourth calculating the mean of such daily differences, fifth calculating the standard deviation of such daily differences, then sixth calculating a daily statistic by subtracting said mean from the daily difference and dividing the result by said standard deviation.

3. The system of claim 2, wherein an outlier in the daily statistic is indicated if the daily statistic is greater than about 2.

4. The system of claim 3, wherein the computer server is further programmed to:
receive news items for the financial security that generated the alert.

5. The system of claim 4, wherein the interactive display device for interacting with a user is further programmed to:
display a chart of movement of the financial security that generated the alert, wherein said chart graphically indicates dates of outliers in trading for that financial security;
receive user input from a graphical indicator device, wherein the user input comprises a selection from said chart of one said outlier; and
display at least one news item associated with said outlier.

6. The system of claim 1, wherein the computer server is further programmed to calculate a volume daily statistic, the volume daily statistic calculated by first calculating the mean of daily volume values for the financial security from the market data, second calculating the standard deviation of daily volume values for the financial security from the market data, then third calculating a daily statistic by subtracting said mean from a daily volume for the financial security and dividing the difference by said standard deviation.

7. The system of claim 6, wherein an outlier in the volume daily statistic is indicated if the volume daily statistic is greater than about 2.

8. The system of claim 1, wherein the computer server is further programmed to:
filter out financial security trades where the quantity of traded securities is less than a specified quantity.

9. The system of claim 1, wherein the computer server is further programmed to:
filter out financial security trades that occur more than a specified number of days before or after an outlier in trading for that financial security.

10. The system of claim 1, wherein the computer server is further programmed to:
filter out financial security trades where a transaction type is buy prior to an outlier that represents a decrease in the price of that financial security.

11. The system of claim 1, wherein the computer server is further programmed to:
filter out financial security trades where a transaction type is sell prior to an outlier that represents an increase in the price of that financial security.

12. The system of claim 1, wherein the computer server is further programmed to:
take an automated action in response to said alert.

13. A system comprising:
a first communication link to a financial company, wherein said financial company provides by said first communication link a description of at least one financial security trade, including at least a trader identifier, trade date, transaction type, security identifier, and quantity;
a second communication link to a source of current financial securities and news data, wherein said source provides by said second communication link data for each security identified in said descriptions of financial security trades, said data including at least price history for the security, volume history for the security, price history for an associated index, and news items about the security;
a computer server coupled to the first communication link and second communication link, and programmed to:
compute a daily percentage change for each such security identified over a specified period of time;
compute a daily percentage change for each such associated index over the specified period of time;
compute a difference between the daily security percentage change and daily associated index percentage change, for each such security identified over the specified period of time;
compute a mean of such differences, for each such security identified over the specified period of time;
compute a standard deviation of such differences, for each such security identified over the specified period of time;
compute a daily z-score for each security identified over the specified period of time, wherein the z-score is said mean for one such security subtracted from said difference for said security on one date, the result of said subtraction then divided by said standard deviation for said security;
generate an alert if one of said at least one financial security trades has a trade date near a date when the z-score for said financial security was more than about 2;
an interactive display devices for interacting with a user, coupled to said computer server, and programmed to receive an alert and display the alert to a user.

14. The system of claim 13, wherein the interactive display device for interacting with a user is further programmed to:
display a chart of movement of the financial security that generated the alert, wherein said chart graphically indicates dates of outliers in trading for that financial security;
receive user input from a graphical indicator device, wherein the user input comprises a selection from said chart of one said outlier;
display at least one news item associated with said outlier.

15. The system of claim 13, wherein the computer server is further programmed to:
filter out financial security trades that occur more than a specified number of days before or after an outlier in trading for that financial security.

16. The system of claim 13, wherein the computer server is further programmed to:
filter out financial security trades where a transaction type is buy prior to an outlier that represents a decrease in the price of that financial security.

17. The system of claim 13, wherein the computer server is further programmed to:
filter out financial security trades where a transaction type is sell prior to an outlier that represents an increase in the price of that financial security.

18. The system of claim 13, wherein the computer server is further programmed to:
take an automated action in response to said alert.

19. A system comprising:
a first communication link to a financial company;
a second communication link to a source of current financial securities and news data;
a computer server coupled to the first communication link and second communication link, and programmed to:
receive, from the first communication link, trade data corresponding to a plurality of financial security trades, each financial security trade associated with a financial security;
receive, from the second communication link, market data for each of said financial securities;
receive, from the second communication link, market index data for an index associated with each of said financial securities;
automatically identify any dates that the movement of any of said financial securities is an outlier, based on said market data and market index data;
automatically identify any of said financial security trades made close to one of said identified dates of outliers for that security, wherein said security trade is an abnormal trading pattern;
in response to identification of at least one abnormal trading pattern in the trading of a financial security, automatically retrieving from the second communication link news items associated with the date of said abnormal trading pattern;
an interactive display device for interacting with a user, coupled to said computer server, and programmed to:
receive an alert from said computer server including at least one said identified abnormal trading pattern;
display a chart of the recent movement of said financial security, wherein said chart graphically indicates dates of said outliers;
receive user input from a graphical indicator device, wherein the user input comprises a selection from said chart of one said outlier; and
display at least one news item associated with said outlier.

20. The system of claim 19, wherein an outlier in the movement of any of said financial securities is determined by first calculating a daily percentage change in price of a financial security from the market data, second calculating a daily percentage change in price of an associated index from the market index data, third calculating the daily difference of the daily percentage change in price of a financial security and the daily percentage change in price of an associated index, fourth calculating the mean of such daily differences, fifth calculating the standard deviation of such daily differences, sixth calculating a daily statistic by subtracting said mean from the daily difference and dividing the result by said standard deviation, then seventh determining the daily statistic is an outlier if the daily statistic is greater than about 2.

21. The system of claim 19, wherein the interactive display device for interacting with a user is further programmed to:
display a chart of movement of the financial security that generated the alert, wherein said chart graphically indicates dates of outliers in trading for that financial security;
receive user input from a graphical indicator device, wherein the user input compromises a selection from said chart of one said outlier;
display at least one news item associated with said outlier.

22. The system of claim 19, wherein the computer server is further programmed to:
filter out financial security trades that occur more than a specified number of days before or after an outlier in trading for that financial security.

23. The system of claim 19, wherein the computer server is further programmed to:
filter out financial security trades where a transaction type is buy prior to an outlier that represents a decrease in the price of that financial security.

24. The system of claim 19, wherein the computer server is further programmed to:
filter out financial security trades where a transaction type is sell prior to an outlier that represents an increase in the price of that financial security.

25. The system of claim 19, wherein the computer server is further programmed to:
take an automated action in response to said alert.
